(19) United States
(12) Patent Application Publication
(10) Pub. No.: US 2011/0084644 A1
(43) Pub. Date: Apr. 14, 2011

(54) METHOD FOR SUPPLYING ELECTRICAL POWER TO A LOAD

(75) Inventor: Thomas Rauner, Blaubeuren (DE)

(73) Assignee: DR. ING. H.C.F. PORSCHE AKTIENGESELLSCHAFT, Stuttgart (DE)

(21) Appl. No.: 12/897,134

(22) Filed: Oct. 4, 2010

(30) Foreign Application Priority Data
Oct. 8, 2009 (DE) 10 2009 048 784.0

(51) Int. Cl. H01M 10/46; H02J 7/00

(52) U.S. Cl. 320/101; 320/137; 320/109; 180/65.29

(57) ABSTRACT

A method is provided for supplying electrical power to a load, with a specific quantity of electrical power of different electrical power production types being drawn from an electrical power supply system by the load. The electrical power that is output by the electrical power supply system is identified in terms of its electrical power production type and the quantity of electrical power drawn by the load is detected separately in accordance with the electrical power production types. This provides the option of illustrating to the electrical power customer the origin of the electrical power which is drawn.

### CROSS-REFERENCE TO RELATED APPLICATIONS

This application claims priority under 35 USC 119 to German Patent Application No. 10 2009 048 784.0 filed on Oct. 8, 2009, the entire disclosure of which is incorporated herein by reference.

### BACKGROUND OF THE INVENTION

1. Field of the Invention

The invention relates to a method for supplying electrical power to a load, with a specific quantity of electrical power of different electrical power production types being drawn from an electrical power supply system by the load.

2. Description of the Related Art

Loads are used, for example, in the domestic sector. The loads draw electrical power, with the origin of the electrical power in terms of different electrical power production types generally not being known to the electrical power customer.

Electrical power generally is created from fossil energy sources and nuclear fuels, and to a lesser extent from renewable energy, such as wind energy, water energy and photovoltaics. Fossil energy sources, such as carbon, have the disadvantage that they are environmentally harmful due to high CO₂ emissions. Energy generated by nuclear fuels presents specific risks associated, for example, with the required final storage and with the generation of energy itself. Regenerative energy sources based, for example, on wind energy, water energy or photovoltaics are preferred from an environmental point of view.

Regenerative energies are becoming more and more important due to the falling energy reserves in the earth. Obtaining this regenerative energy still generally is very complicated and costly at present. Some of these energies are subject to state taxation and tax relief which differ depending on the energy source.

Photovoltaic systems on roofs or in fields currently are state-aided and the producers receive more money for supplying electrical power than is paid for drawing electrical power. This could change in the future and it could become necessary to pay more for externally drawn electrical power than is paid for the electrical power that is supplied to the supply system. In this event, internal use of the electrical power and the sale of electrical power to different customers will become of interest.

In addition to the use of electrical power in the domestic and commercial sectors, electrical power is being used more extensively in electric vehicles and hybrid vehicles. These vehicles are provided with a rechargeable battery that can be recharged while the vehicle is not in service and outputs the energy to the electric motor of the electric vehicle or hybrid vehicle during driving.

U.S. Pat. No. 5,642,270 discloses providing a bidirectional current flow in a charging system for the rechargeable battery of an electric vehicle to charge the battery or, if excess energy should be output by the battery, to return this excess energy to the electrical power supply system. The current is superimposed by encoded information to be able to detect the direction and quantity of current.

The object of the invention is to specify a method for supplying electrical power to a load so that the electrical power customer can see the origin of the electrical power.

The origin of the electrical power is shown, in particular, in ecological and/or economical terms.

### SUMMARY OF THE INVENTION

The invention relates to a method that enables the electrical power output by an electrical power supply system to be identified in terms of its respective electrical power production type. Additionally, the quantity of electrical power that is drawn by the load is detected separately in accordance with the electrical power production types.

The method of the invention therefore allows the electrical power customer to allocate the electrical powers that are drawn or the quantities of electrical power that are drawn to the different electrical power production types. The customer therefore knows the origin of the electric power and can determine whether the electrical power originates from CO₂ harmful industries, such as coal-burning power plants, or from ecologically acceptable sources, for example wind energy, photovoltaics, solar heat or water energy. It would likewise be possible to identify electrical power produced in an atomic power plant. It would also be conceivable to identify and allocate the country of origin.

The electrical power that is output by the electrical power supply system can be drawn by an extremely wide variety of loads. Electric vehicle and hybrid vehicles are examples. These vehicles have rechargeable batteries in which the energy that is output can be stored or temporarily stored. However, energy also can be stored or temporarily stored in the case of other loads. An electric vehicle or hybrid vehicle represents a load that can be disconnected from the electrical power supply system. The load is connected to the electrical power supply system only when electrical power is drawn from said electrical power supply system. After the load is disconnected from the electrical power supply system, the load can be moved independently of the electrical power supply system.

The quantity of electrical power that is drawn by the load can be detected separately in accordance with electrical power production types in various ways. It is considered particularly advantageous when the quantity of electrical power that is drawn by the load is detected by a meter, separately in accordance with electrical power production types. The different electrical power production types also can be identified in different ways. It is considered particularly advantageous when the different electrical power production types are identified by providing the electrical powers of the electrical power production types with different pulses and/or by means of information that is drawn by auxiliary apparatuses.

Provision preferably is made both for the quantity of electrical power drawn by the load to be detected separately in accordance with electrical power production types and also for the quantity of electrical power that is drawn to be included separately in the balance in accordance with the electrical power production type. Therefore, the method of the invention is advantageous from both an ecological point of view and also from an economical point of view.

The invention will be explained in greater detail with reference to FIGS. 1 to 3 and the following description, without being restricted to these details.

### BRIEF DESCRIPTION OF THE DRAWINGS

FIG. 1 is a schematic diagram of an electric power meter incorporated into an electric power supply system.

FIG. 2 is a diagram of the electric power supply system with schematic illustrations of the electric power sources and loads.

FIG. 3 is a diagram showing optional tax plans based on the electric power source type.

### DETAILED DESCRIPTION OF THE PREFERRED EMBODIMENTS

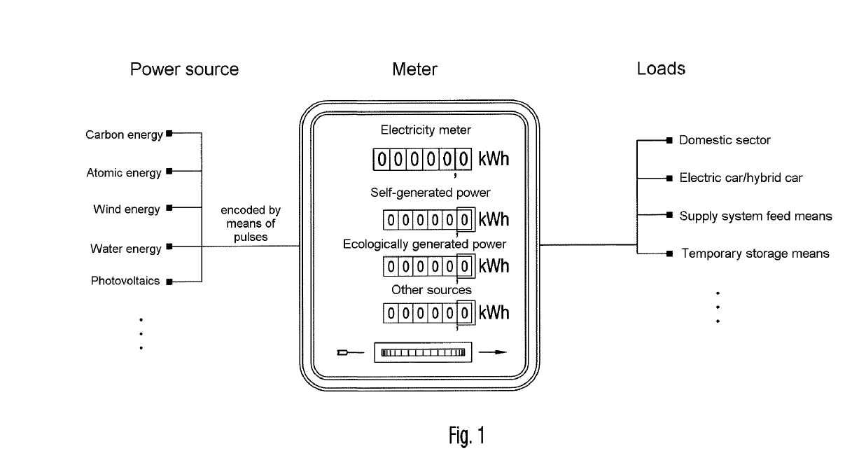

FIG. 1 schematically shows an electric power supply system where electrical power output by the individual electrical power production types of the electrical power supply system are encoded by pulses and are fed to a meter. The meter displays the total quantity of electrical power that is drawn and also displays the partial electrical powers that form this total quantity, specifically “Self-generated electrical power”, “Ecologically generated electrical power” and “Other sources”, for example atomic power. The electrical power then is passed from the meter to the different loads. The currents need not be identified merely by encoded pulses, and other methods for identifying the current types can be used.

The electrical power production types cited in FIG. 1 are carbon energy, atomic energy, wind energy, water energy, photovoltaics, and further electrical power production types, for example in terms of regenerative energy, can be provided. In this figure, the loads cited are, for example, the domestic sector, electric cars/hybrid cars, supply system feed means and temporary storage means.

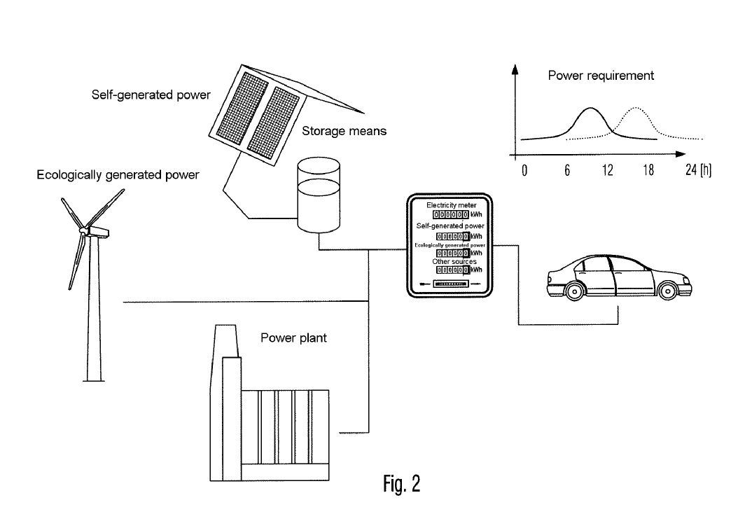

As illustrated in FIG. 2, an electrical power customer can use electrical power obtained at home from a photovoltaic system to charge an electric vehicle/hybrid vehicle that has electrical power storage media. These storage media will be provided in a technically perfected form in the future and accordingly will be able to hold higher capacitances. In addition, the distance covered by vehicles with purely electric driving is increased due to new technical possibilities, and as a result said vehicles become of greater interest.

To allocate the electrical powers, the ecological balance can be determined and therefore an electric vehicle that is operated with electrical power from an ecological source would be entirely CO₂-neutral. If temporary storage means are present, these can output the electrical power that is obtained throughout the day by means of the photovoltaics system, as required, to the load, and therefore, in particular, to the rechargeable battery of the electric vehicle, in the evening.

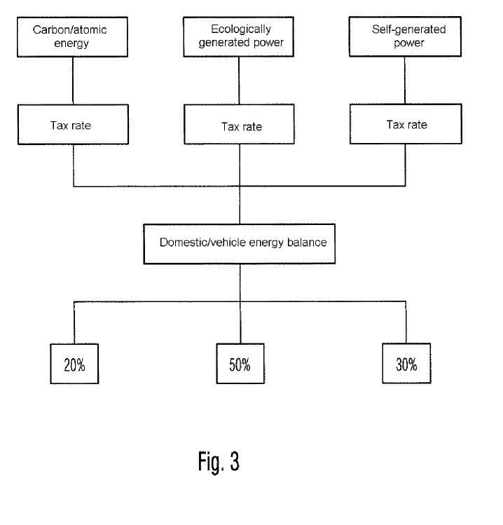

If self-generated electrical power is not available, as is shown in FIG. 2, electrical power can be drawn in a conventional manner, such as by means of a power plant. In this case, the meter measures the electrical power production type and allocates it in a corresponding manner. Software can be used, for example, to read out and to tax (e.g. on a yearly basis) the electrical power that is drawn from the electrical power supply system for a charging current of the battery of the electric vehicle. This is illustrated in FIG. 3. In particular, a lower tax rate is applied to the ecologically more acceptable electrical power than electrical power that is generated using fossil fuels or nuclear fuel.

These different electrical power consumption rates can be included in the balance in accordance with the different electrical power production types, as is conventionally substantially practiced, by a reading-out method or entirely by networked technology using a telephone, the Internet etc. The self-generated electrical power can also be subjected to a different tax rate.

What is claimed is:

1. A method for supplying electrical power, comprising: drawing electric power from an electric power supply system by at least one load, identifying respective electrical power production types drawn from the electrical power supply system by the load; and separately identifying the quantity of electrical power drawn by the load in accordance with the electrical power production types.

2. The method of claim 1, wherein the step of drawing the electrical power comprises drawing the electric power by a load that can be disconnected from the electrical power supply system.

3. The method of claim 1, further comprising at least temporarily storing the electrical power drawn from the electrical power supply system.

4. The method of claim 1, wherein the step of identifying the quantity of electrical power drawn by the load comprises using a meter to detect the electric power in accordance with electrical power production types.

5. The method of claim 1, wherein the step of identifying the different electrical power production types comprises providing currents of the different electrical power production types with different pulses or by information drawn by auxiliary apparatuses.

6. The method of claim 1, wherein the electrical power output by the electrical power supply system is obtained from at least one of fossil energy sources, nuclear fuels or renewable energies.

7. The method of claim 6, wherein the electrical power output by the electrical power supply system is obtained from at least one of atomic energy, carbon energy, wind energy, water energy, photovoltaic or solar heat.

8. The method of claim 1, wherein the electrical power that is output by the electrical power supply system is fed to an electric vehicle or hybrid vehicle.

9. The method of claim 8, wherein the quantity of electrical power which is drawn is detected in the electric vehicle or hybrid vehicle.

10. The method of claim 1, wherein the quantity of electrical power drawn by the load is separately included in a balance in accordance with the electrical power production types.
